(19) United States
(12) Patent Application Publication
(10) Pub. No.: US 2010/0030761 A1
(43) Pub. Date: Feb. 4, 2010

(54) Method of retrieving and refining information based on tri-gram

(76) Inventor: Kaihao Zhao, Bejing (CN)

Correspondence Address: ZHEN ZHENG LU, 1730 HUNTINGTON DRIVE #304, DUARTE, CA, 91010, US

(21) Appl. No.: 11/918,639

(22) PCT Filed: May 22, 2007
(86) PCT No.: PCT/CN2007/001661

§ 371 Date: Oct. 15, 2009

(30) Foreign Application Priority Data
May 22, 2006 (CN) 200610081368.0

(51) Int. Cl. G06F 17/30

(52) U.S. Cl. 707/5; 707/E17.014

(57) ABSTRACT

A method of retrieving and processing information based on ternary model is disclosed, the method includes the steps of: inputting the original file information, producing the keywords into the dictionary of the file; building the ternary relationship model; inputting the relationships of the ternary relationship model into the retrieving database; according to the keywords and the relationship, automatically deriving the new relationship between the keywords; and inputting the keywords and the relationship into the dictionary. During retrieving, after inputting the retrieving keywords, not only the content that searched by traditional method can be retrieved, but the hidden content that not recorded but actually existed in the original file, i.e. implicitly indicating content, can be retrieved by such ternary relationship.

### BACKGROUND OF THE PRESENT INVENTION

1. Field of Invention

The present invention generally relates to a kind of method for retrieving and processing information, and more particularly, relates to a method of retrieving and processing information based on ternary model.

2. Description of Related Arts

The effective retrieving and processing of the data and files is the core and important content in the database area, and widely applied to all kinds of electronic data, literature, business data resource, and network search.

At present, the retrieving techniques for data information in this field generally perform a search by using the Boolean expression as a query term which is based on the keywords. For document database, there is a dictionary storing a lot of keywords and each of the keywords are concretely positioned in the related documents. Depending on such a dictionary, through comparing the keywords of query terms with the one of original documents, the corresponding documents will be retrieved. In addition, in order to improve the retrieving techniques, a fuzzy logic module, a vector space module, and a probabilistic retrieval module are adopted for retrieving documents and data information.

Presently, when doing an information retrieval, the retrieval will be performed by appointing a subject, marking specific keywords, and determining a type of document abstract to identify the property of the original documents, then using the identified property to work as a retrieval keyword during the retrieving process. However, there is a pressing problem with this conventional information retrieval method. The identified property can not completely embody all the information data of the documents. For example, although the content of original documents are related to the query terms, there is no keywords of original documents corresponding to the one of query terms, finally there will be no documents to satisfy the query terms, and the user will retrieve nothing.

### SUMMARY OF THE PRESENT INVENTION

In order to solve the above-mentioned existing problem, the present invention provides a method of retrieving and processing information based on ternary model, which can solve complex search request, such as search a pronoun.

Accordingly, in order to accomplish the above object, the present invention provides a method of retrieving and processing information based on ternary model, comprising the steps of:

(a) inputting the original file information, configuring a dictionary containing keywords and positions of these keywords in the file;

(b) establishing a ternary relationship model comprising a group of Ka, Kr, Kb, wherein Ka stands for keyword a, Kb stands for keyword b, and Kr stands for the relation between the keywords a and b; the ternary group represents and realizes three kinds of association relationship between the keywords; Krᵣ represents the relationship between the relations of keywords, such as inverse relation, secondary relation, same subject, and symmetrical relation, wherein Kr′ stands for the relationship deduced by Kr based on Krᵣ, such that keywords Ka′ and Kb′ have a new relationship Kr′;

(c) inputting the Kr, Krᵣ and Kr′ of the ternary model into a database for retrieving; and

(d) automatically deducing a new relationship between the keywords according to the keywords in step (a) and the relationship in step (c), which is the new relationship Kr′ between the keywords Ka′ and Kb′ and recording the keywords and relationship into the dictionary.

The ternary relationship comprises subordination relationship, equivalent byname relationship and background reference relationship.

The method of the present invention based on ternary model can be combined to be used or applied for many times so as to produce more logical results.

During data retrieving, after a keyword is inputted, not only the data that the conventional method of using keyword dictionary can be found can be found by this method, but also the target of a pronoun that does not recorded in the original file but actually exists can be found based on the above-mentioned ternary relationship.

Comparing to the conventional retrieving systems, the above-mentioned method has the following advantages.
1. The basic data decreases greatly, and the complete basic data is needed to satisfy different searching request, so that all deduced results have to be entered into system as basic data. However, the method of the present invention can deduce many data results to be searched with little basic data.
2. The data that can be searched increases greatly. The data that can be searched by user not only depends on the basic data, but also relates to the number of the ternary groups. The ternary groups is very much universe, so that when one ternary group is added, the data that can be searched increases greatly.
3. The relationship of the data is more consistent. The results are logically deduced by the system so as to be strictly logical. However, in the current searching system, the basic data is independently inputted into the data base, so that the consistency of the data can not be guaranteed.
4. The relationship can be extended. All logical ternary groups can be defined in the system, which means that the relationship obtained according to the life experience and latest technology development can be realized in this method. Furthermore, with the development of the society and the technology development, newly developed relationship can also be realized in this method. After a new ternary group is defined, all previous data are organized immediately to be searched.

### BRIEF DESCRIPTION OF THE DRAWINGS

FIG. 1 is a schematic view of a ternary model according to the present invention.

FIG. 2 illustrates the relation between keywords for retrieving person according to a preferred embodiment of the present invention.

FIG. 3 illustrates the relationship between the relations of keywords according to the above preferred embodiment of the present invention.

FIG. 4 is a deducing schematic view of the inverse relation according to the above preferred embodiment of the present invention.

FIG. 5 is a deducing schematic view of the secondary relation according to the above preferred embodiment of the present invention.

FIG. 6 is a deducing schematic view of same subject relation according to the above preferred embodiment of the present invention.

FIG. 7 is a deducting schematic view of the symmetrical relation according to the above preferred embodiment of the present invention.

### DETAILED DESCRIPTION OF THE PREFERRED EMBODIMENT

The present invention is detailed described with the accompanying drawings and examples as follows.

In order to configure a flexible and intelligent indexing scheme, a kind of self-contained and self-organizing ternary relationship model is established in the present invention. All the common languages comprise main grammatical pattern which includes subject, predicate and object. The present invention simulates this kind of ternary relationship, and based on the ternary relationship model, the data expression, store, and retrieval are realized in the present invention.

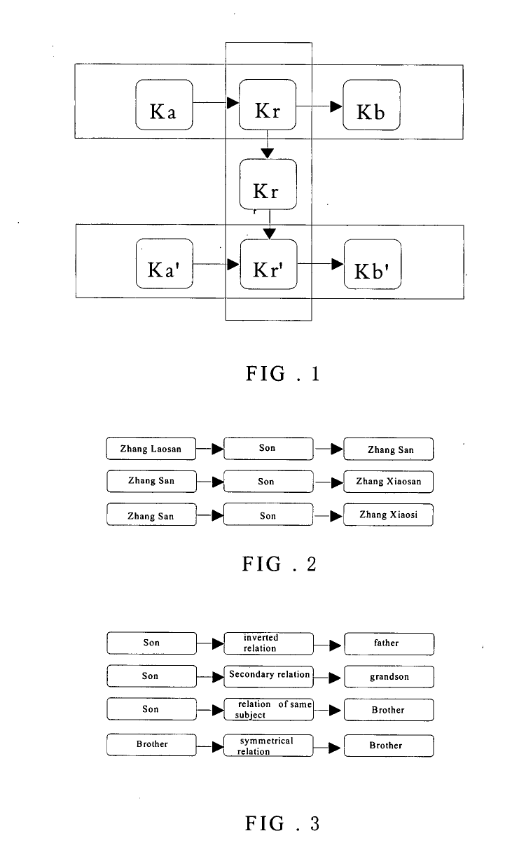

Referring to FIG. 1 the drawings, the ternary relationship model adopts an ternary group of Ka, Kr and Kr, wherein Ka stands for keyword a, Kb stands for keyword b, and Kr stands for the relation between the keywords a and b. The ternary group represents and realizes three kinds of association relationship between the keywords including subordination relationship, equivalent byname relationship and background reference relationship.

Moreover, each of the three kinds of the association relationship between the keywords can be continuously subdivided, and the three kinds of the association relationship can also be realized between the association relationships. The calculation based on the ternary relationship model includes the logical retrieval, which is different from the existing retrieving method by only combining keywords.

Krᵣ represents the relationship between the relations of keywords, such as inverse relation, secondary relation, same subject relation, and symmetrical relation, wherein Kr′ stands for the relationship deduced by Kr based on Krᵣ, such that keywords Ka′ and Kb′ have a new relationship Kr′.

FIG. 2 illustrates an example showing the relationship between the person index keywords. If the person keywords in system includes three ternary groups as follows.

(Zhang Lao San, son, Zhan San); (Zhang San, son, Zhang Xiao San); (Zhang San, son, Zhang Xiao Si).

At the same time, as shown in FIG. 3, ternary groups of the relations of keywords are defined in the system.

(son, inverse relation, father); (son, secondary relation, grandson); (son, same subject, brother);

(brother, symmetrical relation, brother).

So the system will automatically deduce retrieving results without any more information as follows.

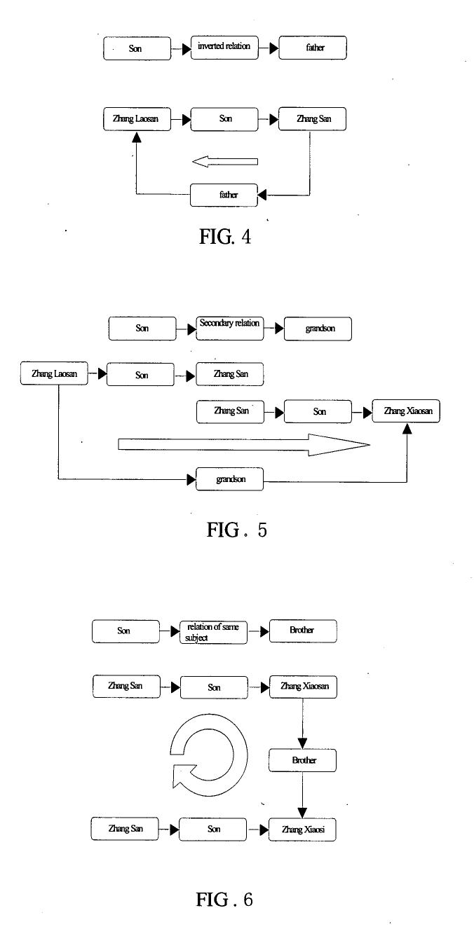

Referring to FIG. 4, based on the inverse relation, the system of the present invention will deduce the follow retrieving results of (Zhang San, father, Zhang Lao San), (Zhang Xiao San, father, Zhang San), and (Zhang Xiao Si, Father, Zhang San).

Referring to FIG. 5, based on the secondary relation, the system of the present invention will deduce the follow retrieving results of (Zhang Lao San, grandson, Zhang Xiao San), (Zhang Lao San, grandson, Zhang Xiao Si).

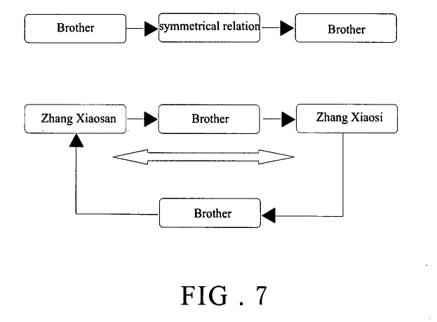

Referring to FIGS. 6 and 7, based on the relation of same subject, the system of the present invention will deduce the follow retrieving result of (Zhang Xiao San, brother, Zhang Xiao Si), and based on the retrieving result obtained from the relation of same subject, the system will deduce the retrieving result of (Zhang Xiao Si, brother, hang Xiao San).

Please notice that the deducing sequence may be different according to different situations.

All the above results are deduced by using relation of the keywords only once. If the relation of more than once or the combination of the relation is used, more logical results can be deduced.

Moreover, the present invention adopts an indexing method, which is similar to the ternary model of keywords. The index is represented and realized by group (C, R, K) and ternary group (Ca, R, Cb), wherein C stands for the content of file, K stands for keywords, and R stands for the relation between the file and the keywords; Ca stands for the content of a, Cb stands for the content of b, and R stands for the relation of a to b. This method records the association relationship of the position, length, and correlation of keywords and the reference between files. Through this kind of indexing, on one hand, the retrieved file can be presented according to the structure of the file; on the other hand, the retrieved file can be shown based on the data source.

What is more, through the ternary group (C, R, K), the indexing method perfectly solves the pronoun problem in the files. For example, an actual target of a pronoun “he” in a file can be determined through ternary group, so that the system can provide user the retrieval of a target of a pronoun, and the keywords of same or similar letter is not required.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A method of retrieving and processing information based on ternary model, comprising steps of:
(a) inputting original file information, configuring a dictionary containing keywords and positions of these keywords in file;
(b) establishing a ternary relationship model comprising a group of Ka, Kr, Kb, wherein Ka stands for keyword a, Kb stands for keyword b, and Kr stands for relation between the keywords a and b; the ternary group represents and realizes three kinds of association relationship between the keywords; Krᵣ represents relationship between the relations of keywords, such as inverse relation, secondary relation, same subject, and symmetrical relation, wherein Kr′ stands for relationship deduced by Kr based on Krᵣ, such that keywords Ka′ and Kb′ have a new relationship Kr′;
(c) inputting Kr, Krᵣ and Kr′ of the ternary relationship model into database for retrieving; and
(d) automatically deducing a new relationship between the keywords according to the keywords in step (a) and the relationship in step (c), which is the new relationship Kr′ between keywords Ka′ and Kb′ and recording keywords and relationships into the dictionary.

2. The method of retrieving and processing information based on ternary model, as recited in claim 1, wherein the ternary relationship comprises subordination relationship, equivalent byname relationship and background reference relationship.

3. The method of retrieving and processing information based on ternary model, as recited in claim 1, wherein in the method, the ternary relationship model can be used for more than once or combined to be used.

4. The method of retrieving and processing information based on ternary model, as recited in claim 1, wherein an indexing method adopting a group (C, R, K) and a ternary group (Ca, R, Cb), wherein C stands for the content of file, K stands for keywords, and R stands for the relation between the file and the keywords; Ca stands for the content of a, Cb stands for the content of b, and R stands for the relation of a to b, wherein the indexing method records association relationship of position, length, and correlation of keywords and references between files.

5. The method of retrieving and processing information based on ternary model, as recited in claim 2, wherein in the method, the ternary relationship model can be used for more than once or combined to be used.

6. The method of retrieving and processing information based on ternary model, as recited in claim 2, wherein an indexing method adopting a group (C, R, K) and a ternary group (Ca, R, Cb), wherein C stands for the content of file, K stands for keywords, and R stands for the relation between the file and the keywords; Ca stands for the content of a, Cb stands for the content of b, and R stands for the relation of a to b, wherein the indexing method records association relationship of position, length, and correlation of keywords and references between files.
